(19) United States
(12) Patent Application Publication
(10) Pub. No.: US 2010/0070077 A1
(43) Pub. Date: Mar. 18, 2010

(54) Programmed calibration and mechanical impulse response application iin robotic automation systems

(75) Inventor: Canh Le, San Jose, CA (US)

Correspondence Address: Walt Froloff, 273D Searidge Rd, Aptos, CA, 95003, US

(73) Assignee: XYZ Automation, San Jose, CA (US)

(21) Appl. No.: 12/283,654

(22) Filed: Sep. 15, 2008

(51) Int. Cl. B25J 19/02; B25J 9/02

(52) U.S. Cl. 700/254; 901/2; 901/46

(57) ABSTRACT

The present invention describes a system and method for monitoring robotic arm drift in an automatic real-time continuous fashion, having a controller, memory, servo motor with encoder, robotic arm manipulator linkages, position decoder and counter logic for each link, software instructions as logic stored in memory for enabling the robot, under control of the controller for receiving proximity sensor data from at least one set of marker and link mounted sensor pair, storing proximity sensor data from pair in the memory, comparing the pair position with previous samples, and raising an alert signal where the pair disparity exceeds a pre-set limit. The sensor set disparity over time plots the mechanical drift which is continuously monitored in real-time during normal work operation and addressed in real-time. Catching drift from impulse loads is done through measurement and analysis of impact loads through a 3D accelerometer on or near the arm end-effector, performing a component decoupling of the acceleration data into the three orthogonal dimensions, and determining forces from accelerometer data for each component dimension and response from or affect on wafer payload.

### BACKGROUND

### Field of the Invention

The present invention generally relates to robotic arm automated calibration and positioning compensation specifically, to the monitoring mechanical operations continuously and automatically adjusting robot characteristics for mechanical and electrical drift, and anomalous events.

Assembly line stoppages in wafer-handling system IC processing significantly inhibit overall tool performance and reliability in manufacturing plants because failures in wafer-handling systems have significant mean time to repair (MTTR).

Based on some chipmaker data, more than 90% of failures were caused by improper placement of the wafer in the robot's end effectors, resulting in broken product wafers during transfer and handling. The problems were usually addressed by the replacement of wafer-handling components or manually recalibrating the handler. Overall, less than 10% of the root causes for failures are clearly identified. The problems are often incorrectly identified as failed system components, including motors, cabling, or the robot itself.

Studies indicate that a number of operands in the reliability equation can be increased with deployment of in situ diagnostic tools in wafer-handling systems, resulting in higher MTBF (mean productivity time between failures) and higher MCBF (mean cycles between failures), based on Semi E10-0701 guidelines.

Predictable Failure

Current robotic wafer-handling systems exhibit a binary behavior, functioning or down. Moreover, these same systems can successfully perform operations even while calibration and functionality of their critical wafer-handling devices are degrading, which leads to expensive consequences if nothing is done during this period to remedy the failing mechanism before catastrophic failure occurs to close the line. Since some relevant parameters are not monitored adequately, and the robotic systems approach critical failures, predictable failures occur, failures which can be mitigated or eliminated with appropriate timely action. What is needed are those monitoring parameters and timely corrective adjustments.

Once a failure occurs, proper diagnosis and analysis frequently require the robot to be removed from the wafer-processing line and delivered to specially designed test fixtures located at the supplier's laboratory. A great deal of cost can be incurred moving the robot between the wafer fab and the supplier's lab. In situ analysis methods are needed, which monitor the performance on line and give warnings when components are degrading or failing. Thus monitoring and smart maintenance are key to reducing costs. What is needed are ways to monitor degradation phenomena, and take measures to eliminate the natural course of consequences with machine vigilance and mitigation actions.

Automatic calibration methods have new found support in controller programmed servos in using references to position. High-resolution encoders provide feedback to the controller, indicating the position of each motor. Controller software continuously compares the actual motor feedback position to the software-commanded motor position to generate appropriate drive signals. The controller's integrated drives provide the necessary motor drive current. Through this tight integration, the controller has real-time knowledge of the velocity and torque of each motor. However, the position feedback can be improved, as there are still catastrophic system failures which are not caught by the current encoder feedback methods. Frequent calibration of robot arm movement to catch electrical and mechanical drift can project and prevent catastrophes caused by the drift. In the “touch calibration” mode, the controller commands a robot axis to slowly move the end effecter into the predefined nominal location for handoff of wafers in process tools. When the end effecter makes light or very close contact, the axis slows down and the motor torque changes, indicating physical contact. The controller captures the encoder position as the calibration point. Since the controller is aware of the precise torque requirements of each motor, touch calibration is achieved with very low contact forces. Sophisticated torque-data processing algorithms are used to eliminate false triggers and ensure calibration consistency despite dynamic mechanical characteristics of the robot. However, the “touch calibration” provides only a vector limit in one arm extension position at best. For training purposes, it would be of benefit to know the individual dimension arm segment limits.

In situ automatic calibration also provides the foundation for additional reliability tools to monitor and diagnose the health of robotic systems while they are being used in manufacturing equipment. These new capabilities can be generally described as wafer-map tuning, calibration tracking, and mechanical-systems monitoring, precise tuned mapping and mechanical system integrity.

### Calibration Approaches

In a series of steps, technicians can calibrate robot end effectors by using leveling tools, turning screws, and nudging robots into desired positions for wafer handling. One major semiconductor equipment OEM has estimated that highly skilled system technicians are only able to calibrate handlers to within 0.5 mm repeatability using manual methods.

A number of “auto-teach” methods have been deployed in recent years to improve upon manual teach methods, but many of these approaches cannot support full in situ diagnostics of handlers. One common auto-teach method uses a combination of specially designed fixtures and sensors placed in the wafer-handling station. In some systems, fixtures detect position using mapping lasers. Others use proximity sensors to detect the location of the end effector. While reducing the time it takes to teach wafer handlers, these approaches also require special fixtures for the end effectors and robots. Often, these special fixtures must be used when handlers are re-calibrated in the field. The use of sensors can also present additional reliability concerns as they require vigilance as well.

Touch-sensing calibration is used to evaluate mechanical integrity of handlers by monitoring the position, velocity, and torque of each motor in the system. However, handlers with mechanically damaged robots can give the false impression that systems are working properly if positions are detected and measured only by calibration sensors. Real-time access to motor torque and other system servo control data supports the ability to provide full in situ analysis of robot performance. What is needed are real-time implementations to detect proper positions to a finer scale, calibrations which can be continuously repeated during the robot movement.

Calibration Quality Tracking

While robot calibration may be successfully achieved when the robot is being set up, the quality of calibration during operation is rarely known. To be certain of continuous monitoring, the calibration sequence must be repeated. However, there is no certainty that the new calibration data is better than the original set-up data. Methods to calibrate and integrate the “drift” into the control mechanism to account drift for in situ without removal or robot removal for repair prematurely are needed.

One solution is to compare incoming calibration data, collected by the controller, and the set-up baseline data while robots are operating. The calibration data is compared to the baseline and significant deviations are recognized as a critical change in the wafer-handling equipment. The equipment can be recalibrated with automatic routines, without special tools and with handler devices in situ. Trends in the change of calibration data are monitored as well. The abilities to monitor the repeatability of calibration and easily perform automatic calibration routines allow the system to maintain performance and wafer-handling. However, these methods only work within tolerances, and the robot will need to be repaired once the tolerances are exceeded. Methods are needed to correct for the drift and even integrate that into the controller motion program, such that drift is accounted for in a continuous fashion, not limited to pre-sets and boundaries of calibration positions.

### Mechanical Integrity

Other methods in situ tool monitor mechanical-system integrity. Wear in a robot's drive mechanism can go unnoticed, resulting in eventual and predictable critical failures. Wear is a normal occurrence in any mechanical device. Changes in lubrication or wear conditions also can alter the dynamic properties of wafer-handling actuators. Any change in the mechanical dynamics causes changes in the required energy to move robots, which is directly related to the torque, acceleration and velocity output of each motor for a given movement.

Following a move sequence, the data demonstrates that motion performance alone does not sufficiently inform the user about the mechanical integrity. Using an in situ method, a user gains knowledge of trends in the motor torque profile and can recognize mechanical deterioration long before a performance failure threshold is met. What are needed are automated implementation aware of these known degradation parameters, so that corrective measures are self initiated, automated, to predict failure and take commensurate counter measured response to stave off failure.

### Training a Robotic Arm

Most robotic arm systems undergo some “training”, that is to program the end-effector locus to complete a task. This training may incur collisions before a collision free effector locus is programmed for a particular task. This training can itself cause damage to the arm or change the arm or end-effector such that the factor characteristics cannot be relied upon to predict failure without possibly changing the characteristics of arm motion. Methods are needed to ascertain the accumulated collision damage to each motor, and dimension from which collisions are accumulated, along with their magnitude nature.

### SUMMARY

The present invention discloses a system and method for robotic arm continuous calibration during arm movement. Since the robotic motion is much slower than sensor measurements and controller processing speeds, the robotic arm speed is not a factor in making full arm link segment measurements of arm position even while in motion. Therefore calibrations of arm segments are done continuously and programmatically.

A system for monitoring and automatic real-time continuous robotic manipulator calibration is described, having a controller, at least one memory, servo motor with encoder, at least one arm link in a robotic arm manipulator, position decoder and counter logic for each link, software instructions as logic stored in memory for enabling the robot, under control of the controller for receiving proximity sensor data from at least one set of marker and link mounted sensor pair, storing proximity sensor data from pair in the memory, comparing the pair position with previous samples, and raising an alert signal where the pair disparity exceeds a pre-set limit. Such that the sensor set disparity over time plots the mechanical drift which is continuously monitored in real-time during normal work operation.

Another aspect of the invention for catching drift from impulse loads describes a method for automatically and continuously monitoring a robotic arm subjected to impact loads comprising the steps of installing a 3D accelerometer on or near the arm end-effector, installing an amplifier to condition the accelerometer signal for digital logic, installing digital logic to read the accelerometer signal and store in readable memory for enabling the arm controller, under control of the processor for: receiving 3D accelerometer data, storing the accelerometer data in the memory, performing a component decoupling of the acceleration data into the three orthogonal dimensions, and determining forces from accelerometer data for each component dimension, whereby 3D impact loads can be assessed and responses for mitigation steps determined for each force component in real-time.

### BRIEF DESCRIPTION OF DRAWINGS

Specific embodiments of the invention will be described in detail with reference to the following figures.

FIG. 1 illustrates a 3D accelerometer instrumented arm multiple linkage robotic arm system with end effecter, in accordance with an embodiment of the invention.

FIG. 2 illustrates a schematic of the servo control with feedback with the addition of continuous monitoring of position, velocity and acceleration time history for impact response analysis of multiple linkage robot system in accordance with an embodiment of the invention.

FIG. 3 shows a high level flow chart of the 3D acceleration response analysis for feedback from an impact load and response analysis and implementation using known equipment characteristics in accordance with an embodiment of the invention.

FIG. 4 illustrates an exemplary 3D acceleration response graph from an impact load, for the individual robotic arm axis in accordance with an embodiment of the invention.

FIG. 5 illustrates a schematic of the servo control with feedback with the addition of continuous multi-segment robotic arm proximity sensor set monitoring of known arm position for comparison with encoder/decoder position data for same known position in accordance with an embodiment of the invention.

FIG. 6 is a position of the calibration proximity sensor set deviation plot as a function of measurements in time in accordance with an embodiment of the invention.

FIG. 7 shows a high level flow chart of the automated calibration procedure using stationary marker sensors and proximity sensors on are segments in accordance with an embodiment of the invention.

FIG. 8 illustrates a high level schematic of the manual brake for a failsafe arm manual safety switch in accordance with an embodiment of the invention.

FIG. 9 illustrates a schematic of the manual brake for a failsafe arm manual safety switch in accordance with an embodiment of the invention.

### DETAILED DESCRIPTION

In the following detailed description of embodiments of the invention, numerous specific details are set forth in order to provide a more thorough understanding of the invention. However, it will be apparent to one of ordinary skills in the art that the invention may be practiced without these specific details. In other instances, well-known features have not been described in detail to avoid unnecessarily complicating the description.

### Objects and Advantages

It is an object of the invention to enable a robotic arm to continuously calibrate electronic and mechanical drift with time while working, and raise warnings when drift dimensions reaches pre-set limits.

It is another object of the invention to provide 3-D impulse response feedback upon robotic arm collisions or impacts.

It is another object of the invention to use 3-D impulse response processing to determine the severity and the direction of the collision.

It is another object of the invention to determine magnitude of damage occurring to the wafer upon robotic arm collision or impacts.

It is another object of the invention to do an frequency decomposition on the impact load function to determine if any response frequencies received impact load frequency forces and moments.

The present invention discloses additional sensors and instrumentation to continuously calibrate the robotic arm links and also to automatically access any damage from impact loads.

Accordingly, it is an object of the present invention to provide more efficient and intelligent diagnostics for monitoring robot mechanism degradation over time so that upgrades are not made too soon, nor repairs too late.

It is an object of the present invention to determine the severity of robotic arm collisions and impacts, automatically, so that repairs and subsequent actions are commensurate with the damage done. Too often an entire system process line is shut down, or an complete robotic arm system is swapped out, when the damage was perhaps minimal, and could be otherwise remedied, had the impact loads been known, and the true impact resultants determined automatically.

It is another object of the present invention to provide embodiments designed for monitoring calibration, calibration trends for predicting upgrade or adjustment time.

It is another object of the present invention to provide methods to terminate manipulator motion when impact loads or drift dimensions exceed specified band limits.

### Embodiments of the Invention

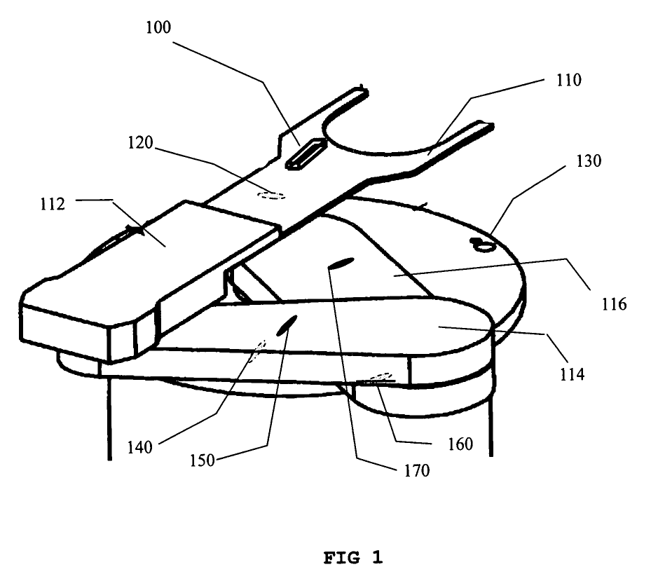

FIG. 1 illustrates a 3D accelerometer instrumented arm multiple linkage robotic arm system with end effecter, in accordance with an embodiment of the invention.

A 3D accelerometer 100 is mounted on the end effector 110. Proximity sensor sets 120 & 150, 140 & 170, 160 & 130, are also shown mounted on the segment to be calibrated and the marker position. The marker position can be another link segment, since all links are monitored and any drift can be added to the marker segment to determine the amount of drift due to just the segment in question. The 3D accelerometer 100 is operatively connected to electronic circuitry, such that any impact on the end effecter or the location of the 3D accelerometer will register the acceleration in the three dimensions, x, y, z or other coordinate system.

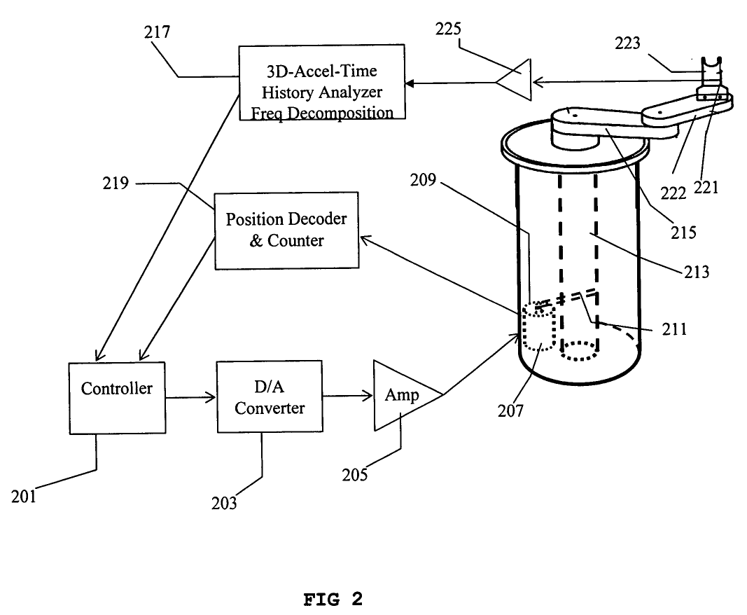

FIG. 2 illustrates a schematic of the servo control with feedback with the addition of continuous monitoring of position, velocity and acceleration from a mounted 3D accelerometer time history for impact response analysis of multiple linkage robot system in accordance with an embodiment of the invention. The 3D accelerometer 221 is mounted on the end effector 223 coupled to the robotic arm segment 222 215 and 213. Each segment or link is servo 207 manipulated 211 and tracked by the encoder 209 position logic 217 which is then transmitted to the controller 201. The 3D accelerometer 221 on the end-effector 223 provides real-time 3D acceleration data amplified 225 to the 3D Acceleration—Time History and Frequency Decomposition logic 217 where it is processed and compared for pre-set limits. Any sudden acceleration impulses from sudden wafer impacts or effector collisions will trigger the 3D accelerations in three orthogonal axis and the logic 217 will process these data for magnitude and component direction of impact. This information is transmitted to the controller 201 for further processing and comparison data from encoder 209 with known position decoder and counter 219 data. The controller 201 logic will then determine whether the impact from each component direction adversely affects the wafer or payload object, the degree of the affect and whether it is safe to continue operation or immediately halt the are operation. The controller logic can compare the component accelerations to determine the vector direction of the impact load. The impact load can also be analyzed for frequency content to determine if the arm segments or wafer can sustain impairment from the impact. The digital to analog converter 203 then drives the operational amplifier 205 circuitry that drives the servo 207.

The controller 201 can be a processor, a microcontroller, microprocessor, or other digital device with a CPU, memory and I/O. The electronics for the hardware or firmware logic for the 3D processing can also be of various technologies including analogy, digital, or mixed mode.

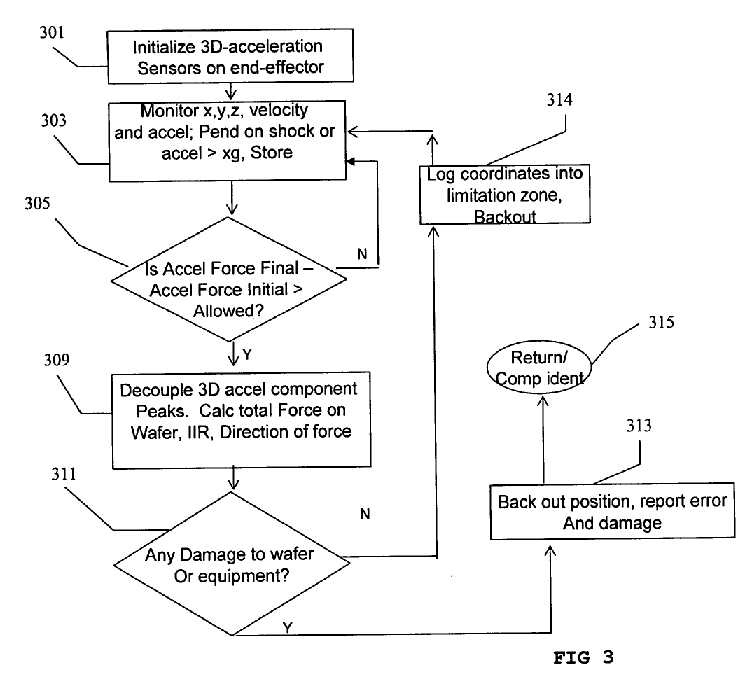

FIG. 3 shows a high level flow chart of the 3D acceleration response analysis for feedback from an impact load and response analysis and implementation using known equipment characteristics in accordance with an embodiment of the invention.

The logic thread initializes the 3D-accelerometer 301, reads in the pre-set parameters and limit, and validates that the device is powered, position, velocity and acceleration are valid. The accelerometer continuously to monitors 303 the acceleration in three orthogonal directions, x, y and z shown here. The pre-set limits will include accelerations in the three component directions. Upon an acceleration load triggering event, a sudden increase from impact or shock, the logic will compare with stored values to determine whether the final or peak acceleration for each of the three component directions, minus the starting or level acceleration measured previously, is greater than the stored g force pre-set 305. If it is not, the logic will thread back and continue to monitor 303. If the acceleration exceeded the pre-set given, the logic will decouple and compare component direction accelerations with preset values and, perform a load analysis and or Infinite Impulse response analysis on each component direction, ascertain the direction that the force came from, and compare that with stored maximum load values, and ascertain the damage and direction that damage originated. 309. A frequency decomposition analysis can show if the response frequencies imparted by the impact could damage the payload on the end-effector. If a threshold of damage to the wafer or arm is not a possibility, the program logic will thread to back out the arm, report the error and magnitude as well as the possible damage 313 calculated. The logic will then execute a return 315 to report the damage and await instructions based on the report. No damage to equipment 311 will execute a branch to instructions for logging and reporting the minor event 314.

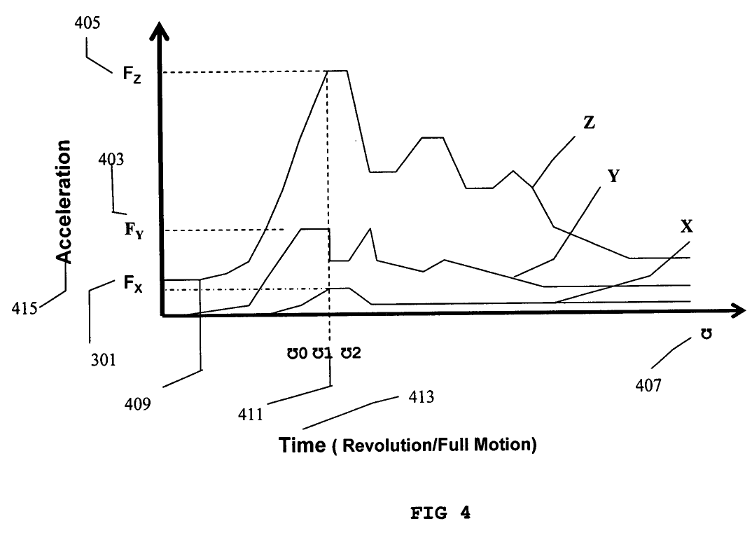

FIG. 4 illustrates an exemplary 3D acceleration response graph from an impact load, for the individual robotic arm axis in accordance with an embodiment of the invention.

FIG. 4 depicts the components of acceleration registered by the 3D accelerometer, in the X, Y and Z directions.

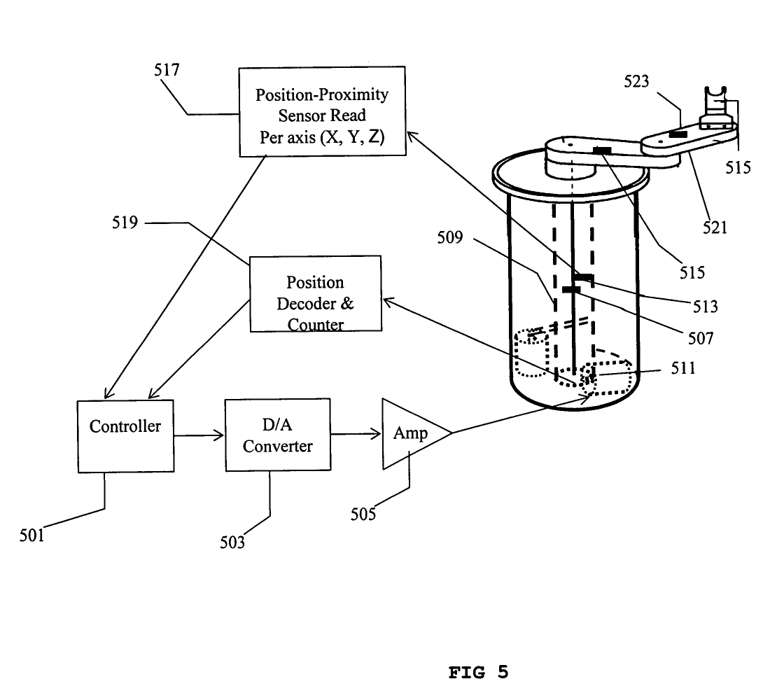

FIG. 5 illustrates a schematic of the servo control with feedback with the addition of continuous multi-segment robotic arm proximity sensor set monitoring of known arm position for comparison with encoder/decoder position data for same known position in accordance with an embodiment of the invention. Proximity sensor sets are shown in FIG. 1 as 120 & 150, 140 & 170, 160 & 130, are coupled to electronic circuitry to report the position of the known marker position at each measurement. These measurements are stored in memory and retrieved by program to track each segment for total drift. Each segment coordinates are decoupled from the other segment coordinates by removing all but that particular segments actual position in ascertaining segment drift. 511 coupled to server 511, driven through a D/A Convert 503 and Amplifier 505.

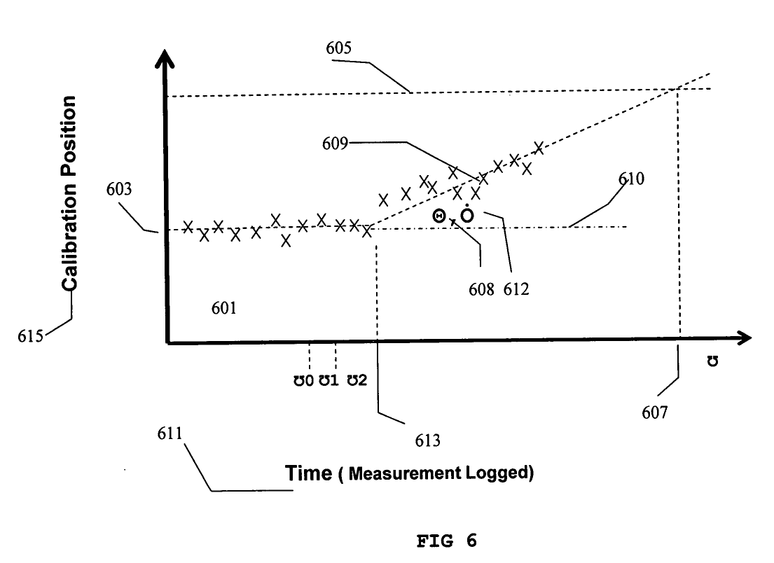

FIG. 5 shows a robotic arm system for automatic continuous real-time monitoring robotic manipulator calibration. A controller 501 has memory and I/O to drive the encoder The Z dimension 509 of the arm link traverses a vertical path on which a marker sensor 507 is placed at a known position. The link or segment of the arm which is manipulated for vertical, Z, motion also contains a proximity or position sensor 513 which triggers signal at reaching the position marker sensor 507 during Z dimension arm operation. The theta and radial manipulation is conducted through the contiguous links 515 and 521, each of which also have marker-proximity sensor pairs as well. Each link 509 515 521 also has its own servo and attached encoder/decoder, positions which are tracked by logic 519 typically residing in the controller 501. Logic as software instructions is stored in memory for enabling the robot arm, under control of the controller 501 to receive proximity sensor data from sets of marker and link mounted sensor pairs, storing proximity sensor data from pair in the memory, comparing the pair position with previous samples, and raising an alert signal where the pair disparity deviation from drift exceeds a pre-set limit. The sensor set disparity over time plots shown in FIG. 6, the mechanical drift which is continuously monitored in real-time for each sensor pair during normal operation.

Some arm links will have movement paths conducive to installing a fixed position marker. But some links will have a marker residing on another movable link. That movable marker link will itself have drift which must be accounted for in the drift calculation logic and must make the accounting incremental dimension adjustment to accurately follow a single link attached to contiguous chain of links to the origin or base of the link position zero.

FIG. 6 is a position of the proximity sensor set position deviation graph as a function of measurements made in time in accordance with an embodiment of the invention.

FIG. 6 shows a continuously calibrating a robot arm segment or link position 615 graph of measurements against time 611 in a given operation cycle 613. Curve fit logic is used to determine the slope of a statistical representative curve 603 610 at start of cycle and link, and is updated continuously as new data is received. After a pre-set number of measurements 613, another slope is calculated 609 using the statistical curve fitting logic. These slopes are extrapolated to find the intersection of a preset calibration position value 605 giving a time 607 estimate on exceeding the set limit 605. The angle 608 between the slopes 610 609 can be also calculated and compared against pre-set values of drift variance. Steeper angles will indicate higher priority failure mechanisms are at play and the need for maintenance will be commensurate with the priority or urgency in time required before allowed margins in the form of pre-set limits are exceeded. By the same token, the rate of change in slope angle 612 is also a variable which is monitored for change above a certain set value. A rapid changing slope indicates that some failure mechanism is accelerating in severity, to the point which can dramatically reduce the time to failure, and hence must be attended to before a routine repair turns into an expensive equipment failure.

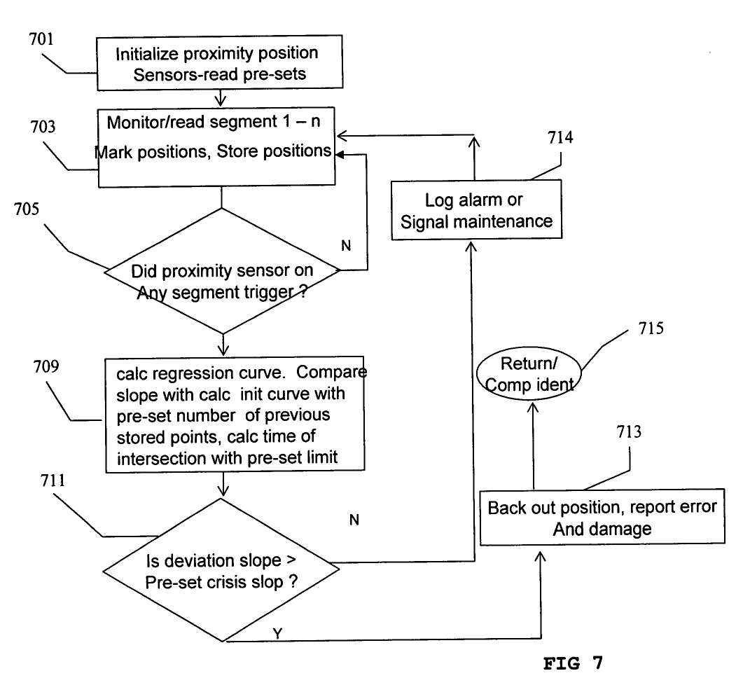

FIG. 7 shows a high level flow chart of the automated calibration procedure using stationary marker sensors and proximity sensors on arm segments in accordance with an embodiment of the invention.

The logic using the installed hardware initializes the marker-proximity sensor pairs and loads the pre-set parameters, limits and constant values 701. The process must account for all links in the chain to the origin axis and continuously senses for signal for proximity contact of moving arm link sensors with its associated proximity marker pair during robotic arm movement, storing proximity contact positions in memory 703. If the a sensor triggered its position marker pair, 705, the measured data is recalculated with the drift logic, for deviations and drift, removing the additional affects from the drift in the chain of links between current link to the origin position, comparing contact positions with previous contact positions for position difference, 709, raising emergency stop 711 where pre-set emergency limits are exceeded, backing out 713 before any damage is made and returning the identified position and link 715. It is important to calculate each linkage segment's drift and rate of drift in robotic arm's position and to precisely determined in real-time and drift exceedence of pre-set limit bands predicted for dependent links in a robotic arm link chain. If not an emergency situation, the incident is logged for maintenance 714 and the process continues 703 to monitor.

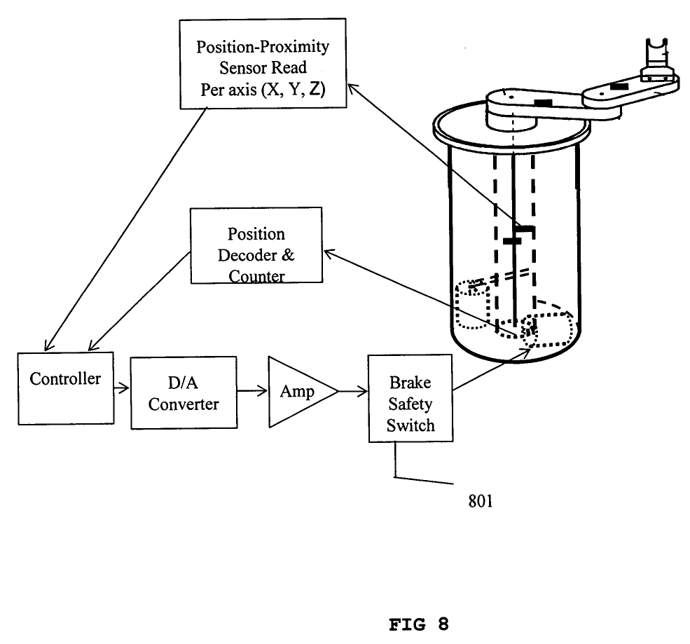

FIG. 8 illustrates a high level schematic of the manual brake for a failsafe arm manual safety switch in accordance with an embodiment of the invention. The brake 801 is designed to de-energize the servo and to unpin anything caught in the failsafe position, such as an appendage or body. In an embodiment of the invention, the brake 801 acts as a safety switch for humans, directing the arm linkage to withdraw from something that could be impeding an otherwise good move, and then to de-energize.

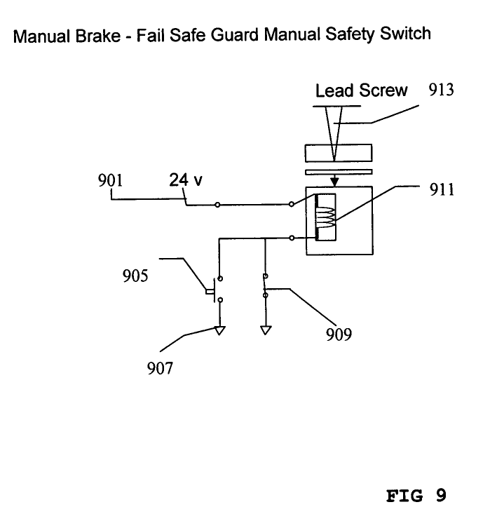

FIG. 9 illustrates a schematic of the manual brake for a failsafe arm guard manual safety switch in accordance with an embodiment of the invention. 24 volts 901 powers the solenoid 911 which is engaged through command switch 909 to complete the circuit. The switch is connected to ground 907 or effective ground generally under the command switch 907. In the event of a failure, the arm will attempt to move to the fail safe position. In the event that a limb is caught by the arm returning, the manual toggle switch 905 will allow a pinned limb to be released, grounding the failsafe override circuit loop to relax the arm brake switch which can be manually engaged to release an object pinned by any arm link at failsafe condition. The brake switching circuit contains a manual switch 905 to ground normally open and in parallel with an electronically commanded switch 907 to ground normally closed at failsafe condition.

Therefore, while the invention has been described with respect to a limited number of embodiments, those skilled in the art, having benefit of this invention, will appreciate that other embodiments can be devised which do not depart from the scope of the invention as disclosed herein. Other aspects of the invention will be apparent from the following description and the appended claims.

What is claimed is:

1. A method for automatically and continuously monitoring a robotic arm calibration comprising the steps of:
installing at least one fixed position proximity marker along a robotic arm link travel path,
installing at least one proximity sensor on a robotic arm link;
continuously sensing for signal for proximity contact of moving arm link sensor with proximity marker during robotic arm movement,
storing proximity contact positions in memory;
comparing contact positions with previous contact positions for position difference,
removing the additional affects from the drift in the chain of links between current link and the origin,
raising alerting signals where difference is above set margins,
whereby each linkage segment's drift rate of drift in robotic arm's position and can be precisely determined in real-time and drift exceedence of pre-set limit bands predicted.

2. The method for continuously calibrating a robot arm as in claim 1 further comprising the steps of:
plotting proximity sensor measurements against time in an operation cycle for a given link,
determining slope of a statistical representative curve at start of cycle and link,
determining slope of a preset number of measurements, N, after an initial number of measurements, M, statistical representative curve for that cycle and link,
determining approximate time sloped curve intersects pre-set limit band at current slope and position and
reporting the expected time of failure.

3. The method for continuously calibrating a robot arm as in claim 1 further comprising the steps of:
plotting a pre-set number, N, proximity sensor measurements against time,
determining the slope of a statistical representative curve from start of new operation cycle time and arm link,
determining slope of a statistical representative curve from an M pre-set number of measurements greater than N in the operation cycle and link,
determining the difference between the two slopes, and
comparing against a pre-set angle for slope departure severity or alarm.
reporting the slope of sensor reading departure.

4. The method for continuously calibrating a robot arm as in claim 3 further comprising the steps of:
determining slope of a statistical representative curve from an M1 pre-set number of measurements greater than N+M in the operation cycle and link,
determining the difference between M and M1 slopes,
determining the slope rate of change, and
comparing against a pre-set slope rate of change with the determined slope rate of change for magnitude severity or alarm.
reporting the slope rate of change.

5. The method for continuously calibrating a robot arm as in claim 1 further comprising the steps of:
installing at least one fixed position proximity marker on another robotic arm link, and adjusting the marker known position with drift from the chain of links which support the link contiguously from the arm origin position.

6. A method for automatically and continuously monitoring a robotic arm subjected to impact loads comprising the steps of:
installing a 3D accelerometer on or near the arm end-effector,
installing an amplifier to condition the accelerometer signal for digital logic,
installing digital logic to read the accelerometer signal and store in readable memory for enabling the arm controller, under control of the processor for:
receiving 3D accelerometer data,
storing the accelerometer data in the memory,
performing a component decoupling of the acceleration data into the three orthogonal dimensions, and
determining forces from accelerometer data for each component dimension,
whereby 3D impact loads can be assessed and responses for mitigation steps determined for each force component in real-time.

7. A system for monitoring and automatic real-time continuous robotic manipulator calibration comprising:
a controller;
at least one memory;
at least one servo motor with at least one encoder;
at least one arm link in a robotic arm manipulator;
position decoder and counter logic for each link;
software instructions as logic stored in memory for enabling the robot, under control of the controller comprising:
receiving proximity sensor data from at least one set of marker and link mounted sensor pair,
storing proximity sensor data from pair in the memory,
comparing the pair position with previous samples, and
raising an alert signal where the pair disparity exceeds a pre-set limit,
whereby the sensor set disparity over time plots the mechanical drift which is continuously monitored in real-time during normal work operation.

8. The system for monitoring and automatic real-time continuous robotic manipulator calibration as in claim 7 further comprising:
proximity sensor measurements during a normal operation cycle for a given link,
logic for determining slope of a statistical representative curve at start of cycle and link,
logic for determining slope of a preset number of measurements, N, after an initial number of measurements, M, statistical representative curve for that cycle and link,
logic for determining approximate time sloped curve intersects pre-set limit band at current slope and position.

9. The system for monitoring and automatic real-time continuous robotic manipulator calibration as in claim 7 further comprising:
proximity triggered sensor measurements during a normal operating cycle,
logic for determining a statistical representative curve from start of new operation cycle time and arm link,
logic for determining slope of a statistical representative curve from last N pre-set number of measurements in the operation cycle and link,
logic for determining the difference between the two slopes, and
logic for comparing against a pre-set angle for slope departure severity or alarm.

10. The system for monitoring and automatic real-time continuous robotic manipulator calibration as in claim 7 further comprising:
at least one fixed position proximity marker on another robotic arm link, and
logic for adjusting the marker known position with drift error from the individual drifts from the chain of links supporting the link contiguously from the robotic arm origin position.

11. The system for monitoring and automatic real-time continuous robotic manipulator calibration as in claim 7 further comprising a brake switch which can be manually engaged to release an object pinned by any arm link at failsafe condition, brake switch circuit mechanism comprising a manual switch to ground normally open and in parallel with a commanded switch to ground normally closed at failsafe condition.

12. A computer program residing in computer-readable medium, for automatically and continuously monitoring a robotic arm calibration comprising the steps of:
installing at least one fixed position proximity marker along a robotic arm link travel path,
installing at least one proximity sensor on a robotic arm link;
continuously sensing for signal for proximity contact of moving arm link sensor with proximity marker during robotic arm movement,
storing proximity contact positions in memory;
comparing contact positions with previous contact positions for position difference,
removing the additional affects from the drift in the chain of links between current link and the origin,
raising alerting signals where difference is above set margins,
whereby each linkage segment's drift rate of drift in robotic arm's position and can be precisely determined in real-time and drift exceedence of pre-set limit bands predicted.

13. The computer program residing in computer-readable medium as in claim 12, further comprising:
plotting proximity sensor measurements against time in an operation cycle for a given link,
determining slope of a statistical representative curve at start of cycle and link,
determining slope of a preset number of measurements, N, after an initial number of measurements, M, statistical representative curve for that cycle and link,
determining approximate time sloped curve intersects pre-set limit band at current slope and position.

14. The computer program residing in computer-readable medium as in claim 12, further comprising:
plotting proximity sensor measurements against time,
determining a statistical representative curve from start of new operation cycle time and arm link,
determining slope of a statistical representative curve from last N pre-set number of measurements in the operation cycle and link,
determining the difference between the two slopes, and
comparing against a pre-set angle for slope departure severity or alarm.

15. The computer program residing in computer-readable medium as in claim 12, further comprising:
installing at least one fixed position proximity marker on another robotic arm link, and adjusting the marker known position with drift from the chain of links which support the link contiguously from the arm origin position.

16. A computer program residing in computer-readable medium, for automatically and continuously monitoring a robotic arm subjected to impact loads comprising the steps of:
installing a 3D accelerometer on or near the arm end-effector,
installing an amplifier to condition the accelerometer signal for digital logic,
installing digital logic to read the accelerometer signal and store in readable memory for enabling the arm controller, under control of the processor for:
receiving 3D accelerometer data,
storing the accelerometer data in the memory,
performing a component decoupling of the acceleration data into the three orthogonal dimensions, and
determining forces from accelerometer data for each component dimension,
whereby 3D impact loads can be assessed and responses for mitigation steps determined for each force component in real-time.
